(19) United States
(12) Patent Application Publication
(10) Pub. No.: US 2021/0374467 A1
(43) Pub. Date: Dec. 2, 2021

(54) CORRELATED SLICE AND VIEW IMAGE ANNOTATION FOR MACHINE LEARNING

(71) Applicant: FEI Company, Hillsboro, OR (US)

(72) Inventors: Derek Higgins, Hillsboro, OR (US); Brad Larson, Hillsboro, OR (US)

(73) Assignee: FEI Company, Hillsboro, OR (US)

(21) Appl. No.: 16/888,337

(22) Filed: May 29, 2020

(51) Int. Cl. G06K 9/62; G06F 3/0482; G06F 3/0484; G06N 20/00

(52) U.S. Cl. CPC G06K 9/6253; G06K 9/6256; G06K 9/6263; G06N 3/08; G06F 3/04845; G06N 20/00; G06F 3/0482

(57) ABSTRACT

Methods and systems for allowing users operators to quickly and easily (i) review the products of machine learning algorithm(s) to evaluate their accuracy, (ii) make corrections to such products, and (iii) compile feedback for retraining the algorithm(s) are disclosed. An example method includes acquiring a plurality of correlated images of a sample, determining one or more features in each image of the plurality of correlated images, and then determining a relationship between at least a first feature in a first image of the plurality of correlated images and at least a second feature in a second image of the plurality of images. Then, when characteristic information is determined about the first feature, it is associated with both the first feature in the first image and the second feature in the second image based on the relationship

### BACKGROUND OF THE INVENTION

Supervised machine learning has the potential to enable accurate and efficient algorithmic solutions for automating specific functions, such as image annotation. However, the creation of supervised machine learning algorithms requires that thousands of training images be manually annotated by a user operator so that the algorithm(s) can be trained to perform the desired function. Moreover, in addition to creating the initial training set, building supervised machine learning algorithms also require that user operators manually (i) review the products of the algorithm(s) to evaluate their accuracy, (ii) make corrections to such products, and (iii) compile feedback for retraining the algorithm(s). Because each of these steps takes hundreds to thousands of user-hours, using current processes, it presently takes months for supervised machine learning algorithms to be created.

This resource burden currently prevents supervised machine learning from being used to develop algorithmic solutions for many current problems. For example, in charged particle microscopy, there are many use cases where microscopy images need to be annotated to highlight different features/characteristics of interest. While such use cases could significantly improve their efficiency with supervised machine learning, many such use cases occur in small business or academia where the resource outlay to train a supervised machine learning algorithm to achieve their desired function is impractical. Accordingly, to allow for supervised machine learning algorithms to be more widely adopted, it is desired to have new methods and resources that make the process of training, evaluation, optimization, and retraining supervised machine learning algorithms easier, faster, and cheaper.

### SUMMARY

Methods and systems for allowing users operators to quickly and easily (i) review the products of machine learning algorithm(s) to evaluate their accuracy, (ii) make corrections to such products, and (iii) compile feedback for retraining the algorithm(s) are disclosed. An example method includes acquiring a plurality of correlated images of a sample, determining one or more features in one or more images of the plurality of correlated images, and then determining a relationship between at least a first feature in a first image of the plurality of correlated images and at least a second feature in a second image of the plurality of images. Then, when characteristic information is determined about the first feature, it is associated with both the first feature in the first image and the second feature in the second image based on the relationship. The methods and systems also include an example method of presenting a graphical user interface that is specially configured to allow a user to quickly and easily review and edit the plurality of labeled correlated images of a sample.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicates similar or identical items.

FIG. 1 illustrates environment for using, training, optimizing, and retraining supervised machine learning algorithms for use cases that involve correlated images.

FIG. 2 is a schematic diagram illustrating an example computing architecture for using, training, optimizing, and retraining supervised machine learning algorithms for use cases that involve correlated images.

FIG. 3 depicts a sample process for using, training, optimizing, and retraining supervised machine learning algorithms for use cases that involve correlated images.

FIG. 4 shows a set of diagrams that illustrate a process for using, training, optimizing, and retraining supervised machine learning algorithms for use cases that involve correlated images.

FIG. 5 shows a set of diagrams that illustrate a first example process that allows a user to quickly and easily review characterization information for a set of correlated images.

FIG. 6 shows a set of diagrams that illustrate a second example process that allows a user to quickly and easily review characterization information for a set of correlated images.

Like reference numerals refer to corresponding parts throughout the several views of the drawings. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

### DETAILED DESCRIPTION OF EMBODIMENTS

Methods and systems for quickly and easily using, training, optimizing, and retraining supervised machine learning algorithms for use cases that involve correlated images are disclosed herein. Thus, the methods and systems described in the present disclosure allow supervised machine learning algorithms to be generated and applied to specific problems/use cases for which current user resource burdens and/or user expertise requirements prevent their utilization.

Included in the disclosure are methods and systems that allow for supervised machine learning algorithms to be quickly and easily trained to annotate correlated images in the field of microscopy. By utilizing the correlated images of specimens generated in microscopy, the disclosed methods and systems allow supervised machine learning algorithms to be trained, used, and optimized to annotate the specific features/characteristics of interest desired by individual users. Correlated images within the scope of the present disclosure correspond to a series of images where at least a portion of the features depicted in an image within the series is present in a subsequent image in the series. Generally, such a series of images will correspond to plurality of images of an object/region of interest, where at least one or more characteristics of the image (e.g., depth, translational position, time, focus, etc.) is varied between the individual images of the series of images. For example, a correlated image set may correspond to a series of electron microscopy images of a region of interest on a semiconductor chip at different depths (i.e., where a layer of matter is removed from the surface of the region of interest between each image).

Also included in the disclosure are methods and systems for generating graphical user interfaces (GUIs) that allow a user to quickly and easily (i) annotate correlated images, (ii) review the products of a machine learning algorithm to evaluate their accuracy, (iii) make corrections to such products, (iv) train a supervised machine learning algorithm to annotate correlated images, and/or (v) retrain such a supervised machine learning algorithm.

Applicant notes that much of the figures and specification present the methods and systems in the context of electron microscopy. However, this is only an illustration of a particular application of the inventions disclosed herein, and the methods and system may be used to (i) annotate correlated images, (ii) review the products of a machine learning algorithm to evaluate their accuracy, (iii) make corrections to such products, (iv) train a supervised machine learning algorithm to annotate correlated images, and/or (v) retrain such a supervised machine learning algorithm for other applications.

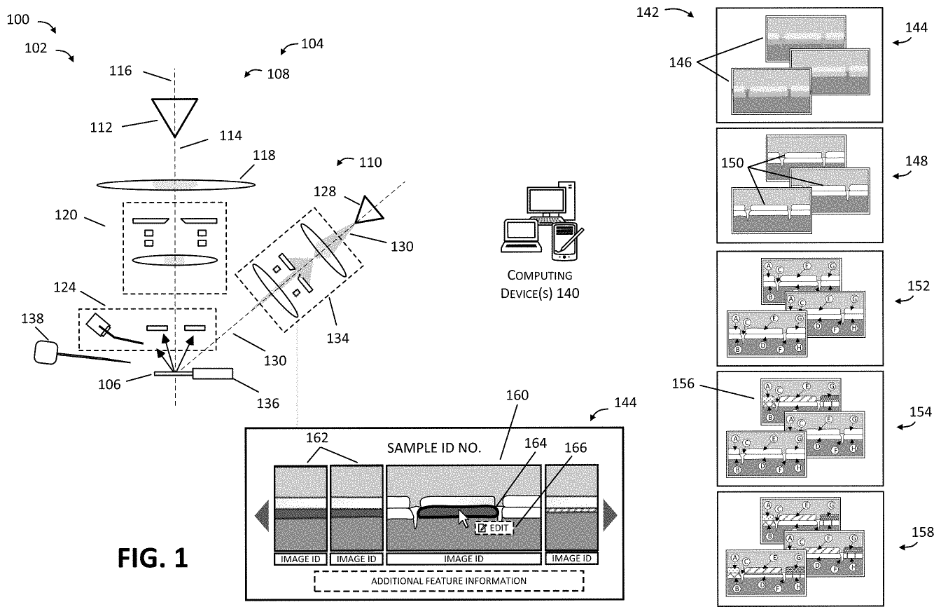

FIG. 1 is an illustration of an environment 100 for using, training, optimizing, and retraining supervised machine learning algorithms for use cases that involve correlated images. Specifically, FIG. 1 shows an example environment 102 that includes an example correlated image acquisition system 104 for generating correlated images of a sample 106. The example correlated image acquisition system(s) 104 is illustrated in FIG. 1 as being a dual beam microscopy system including a scanning electron microscope (SEM) column 108 and a focused ion beam (FIB) microscope column 110.

Other example correlated image acquisition system(s) 104 may be or include one or more different types of optical, and/or charged particle microscopes, such as, but not limited to, a scanning electron microscope (SEM), a scanning transmission electron microscope (STEM), a transmission electron microscope (TEM), a charged particle microscope (CPM), a cryo-compatible microscope, focused ion beam (FIB) microscope, dual beam microscopy system, or combinations thereof. Moreover, it is noted that the present disclosure is not limited to environments 100 where the correlated image acquisition system 104 is a microscope system. For example, other embodiments within the scope of the disclosure may include environments 100 may include a different type of correlated image acquisition system (e.g., a camera), or may not include a correlated image acquisition system 104 at all.

The example correlated image acquisition system(s) 104 includes an electron source 112 (e.g., a thermal electron source, Schottky-emission source, field emission source, etc.) that emits an electron beam 114 along an electron emission axis 116 and towards the sample 106. The electron emission axis 116 is a central axis that runs along the length of the example correlated image acquisition system(s) 104 from the electron source 112 and through the sample 106.

An accelerator lens 118 accelerates/decelerates, focuses, and/or directs the electron beam 114 towards an electron focusing column 120. The electron focusing column 120 focuses the electron beam 110 so that it is incident on at least a portion of the sample 106. In some embodiments, the electron focusing column 120 may include one or more of an aperture, deflectors, transfer lenses, scan coils, condenser lenses, objective lens, etc. that together focus electrons from electron source 112 onto a small spot on the sample 106. Different locations of the sample 106 may be scanned by adjusting the electron beam direction via the deflectors and/or scan coils. Additionally, the focusing column 120 may correct and/or tune aberrations (e.g., geometric aberrations, chromatic aberrations) of the electron beam 114. For example, the focusing column 120 may cause the electron beam to be scanned across a region of interest on the surface of the sample 106 so that an image of the region of interest can be generated.

The FIB column 110 is shown as including a charged particle emitter 128 configured to emit a plurality of ions 130 along an ion emission axis 132. The ion emission axis 132 is a central axis that runs from the charged particle emitter 128 and through the sample 106. The FIB column 110 further includes an ion focusing column 134 that comprises one or more of an aperture, deflectors, transfer lenses, scan coils, condenser lenses, objective lens, etc. that together focus ions from charged particle emitter 128 onto a small spot on the sample 106. In this way, the elements in the ion focusing column 134 may cause the plurality of ions 130 to image and/or alter the surface of the sample 106. For example, the ion focusing column 134 may cause the plurality of ions 130 to change the surface of the sample via milling and/or deposition.

Electrons or charged particles 122 emitted from the sample 106 in response to one of the electron beam 114 or the ion beam 130 being incident on the sample 106 may be detected by a microscope detection system 124. The microscope detection system 124 comprises one or more imaging sensor(s) that are configured to generate detector data based on the electrons and/or charged particles they detect. For example, a particular imaging sensor may be configured to detect backscattered, secondary, or transmitted electrons, that are emitted from the sample as a result of the sample being irradiated with the electron beam 114.

While shown in FIG. 1 as being mounted above the sample 106, a person having skill in the art would understand that the microscope detection system 124 may include imaging sensors that are mounted at other locations within the example charged particle microscope system(s) 104, such as but not limited to, below the sample 106.

FIG. 1 further illustrates the example correlated image acquisition system(s) 104 as further including a sample holder 136, a sample manipulation probe 138, and computing devices 140. The sample holder 136 is configured to hold the sample 106, and is able to translate, rotate, and/or tilt the sample 106 in relation to the example correlated image acquisition system(s) 104. Similarly, the sample manipulation probe 138 is configured to hold, transport, and/or otherwise manipulate the sample 106 within the example correlated image acquisition system(s) 104. For example, the sample manipulation probe 138 may be used to transport a lamella created from a larger object to a position on the sample holder 136 where the lamella can be investigated and/or analyzed by the correlated image acquisition system.

The computing device(s) 140 are configured to generate correlated images of sample 106 within the example correlated image acquisition system(s) 104 based on the detector data generated by the microscope detection system 124. In some embodiments, the images are grayscale images that show contrasts indicative of the shape and/or the materials of the sample. In some embodiments, the computing system 140 is configured to cause the system correlated image acquisition system(s) 104 to generate a set of correlated images of the sample. For example, the computing system 140 may at least partially drive a process where the electron beam 114 is scanned across a region of interest on the surface of the sample to acquire a plurality of images, where between the acquisition of each image a layer of matter is removed from the region of interest by the ion column 110. In this way, each image of the set of correlated images corresponds to an image of the region of interest at a different depth. Alternatively or in addition, the computing system 140 may at least partially drive a process where the electron beam 114 is scanned across a region of interest on the surface of the sample to acquire a plurality of images, where between the acquisition of each image the sample holder 136 causes a translation of the sample relative to the correlated image acquisition system(s) 104.

According to the present disclosure, the computing device(s) 140 are further configured to perform processes utilizing supervised machine learning algorithms to annotate correlated images. In some embodiments the computing devices further perform processes to allow a user to quickly and easily (i) review the products of a machine learning algorithm to evaluate their accuracy, (ii) make corrections to such products, (iii) train a supervised machine learning algorithm to annotate correlated images, and/or (v) retrain such a supervised machine learning algorithm to improve accuracy.

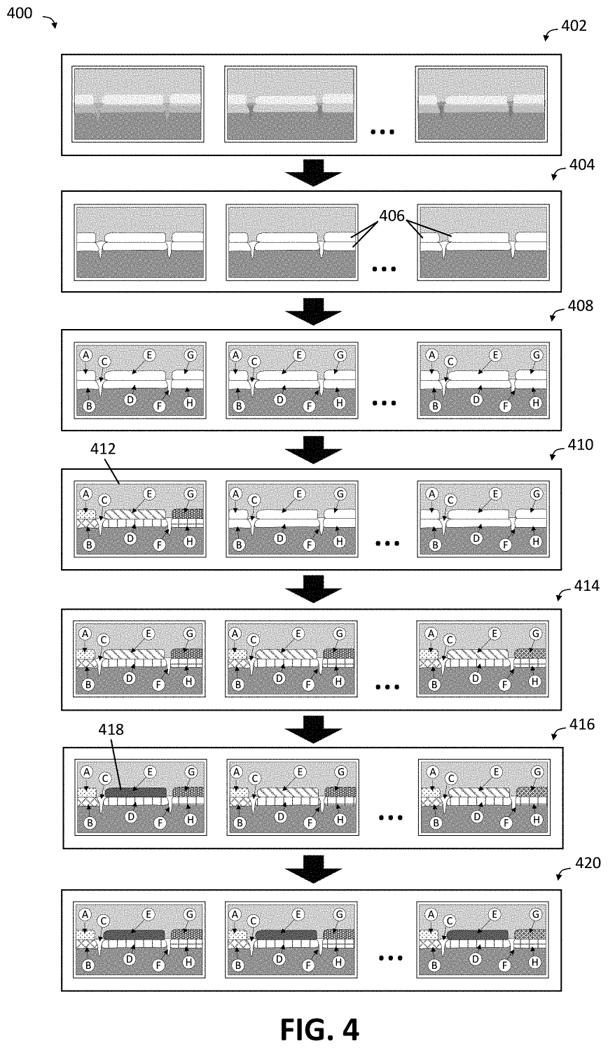

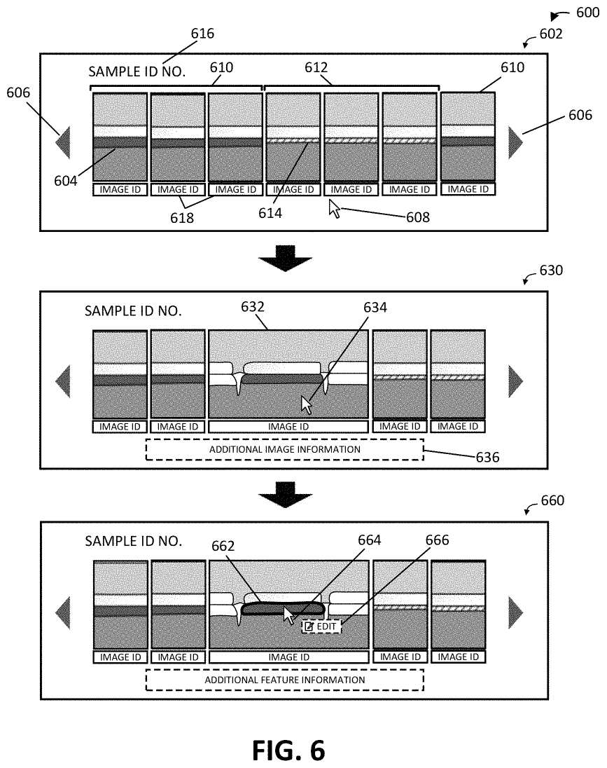

FIG. 1 also depicts a visual flow diagram 142 of a process for using supervised machine learning algorithms to annotate correlated images, and an example GUI 144 for allowing users to (i) annotate correlated images, (ii) review the products of a machine learning algorithm to evaluate their accuracy, (iii) make corrections to such products, (iv) train a supervised machine learning algorithm to annotate correlated images, and/or (v) retrain such a supervised machine learning algorithm for other applications. These are representations of the process and algorithms described in association with FIGS. 4 and 6, respectively.

Flow diagram 140 begins with the image 146 which shows the computing devices 140 acquiring a plurality of correlated images of a sample 146. The computing devices 140 may generate the images 146 (e.g., from detector data from a correlated image acquisition system(s) 104), or the images 146 may be downloaded onto the computing devices 140 via a network connection, disc, portable drive, or other file transfer medium. Image 148 illustrates the computing devices 140 applying a machine learning algorithm to identify features 150 within each of the correlated images 146. The machine learning algorithm may be a supervised machine learning algorithm that has been trained to identify certain types of features (i.e., particular features that a user is interested in).

Image 152 shows the computing devices 140 applying a machine learning algorithm to identify related features in different images. Specifically, image 152 shows the machine learning algorithm identifying features A-H in one or more images. While not pictured in FIG. 1, in some embodiments one or more of the images in the correlated image set may have no features. Image 154 shows classification information being associated with the features in a first image 156. In various embodiments the classification information may be inputted by a user, determined by a machine learning algorithm, imported from a data file that identifies the characteristics of the object depicted in the images 146, or a combination thereof. Finally, image 158 shows the computing devices 140 using the relationships determined by the machine learning algorithm to propagate the characteristics to other images in the correlated image set. In this way, the computing devices 140 are able to quickly and easily annotate and/or input other characteristic information to the features depicted throughout an entire correlated image set. Using prior techniques, such a process of manually annotating each of the features in an entire image set took hundreds of user hours.

FIG. 1 also depicts example GUI 144 for allowing users to (i) annotate correlated images, (ii) review the products of a machine learning algorithm to evaluate their accuracy, (iii) make corrections to such products, (iv) train a supervised machine learning algorithm to annotate correlated images, and/or (v) retrain such a supervised machine learning algorithm for other applications.

FIG. 1 shows a selected feature 164 that has been selected by the user, and the example GUI 144 presenting an option to edit 166 the characteristic information associated with the selected features 164. The example GUI 144 displays a representation of individual images in the set of correlated images. The example GUI 144 depicted in FIG. 1 presents a full view 160 of one image and partial view 162 of multiple other images. In some embodiments, the particular image within the correlated image set that is shown in a full view corresponds to an image that is selected and/or is otherwise interacted with by the user. For example, the image that is presented in full view may correspond to an image that a cursor is positioned over. In some embodiments, the computing devices 140 may optionally cause additional feature information to be displayed based on the GUI 144 based on the selection of the selected feature 164.

If a user edits the characteristic information associated with the selected feature 164, the computing devices 140 may propagate the edit to related features in the correlated image set (e.g., using the relationships generated by the machine learning algorithm). Alternatively, if a user edits the relationships between the selected feature 164 and another feature, the corresponding machine learning generated relationship may be updated to incorporate the edit. For example, where the user identifies an incorrect feature characteristic and/or relationship that was generated by the supervised machine learning algorithm, the user can correct the error with a few quick selections. In this way, a user can rapidly examine a large set of correlated images that have been annotated by a machine learning algorithm and make corrections to any errors. In some embodiments, the computing devices may use the edits received via the GUI 144 to retrain the machine learning algorithm.

Those skilled in the art will appreciate that the computing devices 140 depicted in FIG. 1 are merely illustrative and are not intended to limit the scope of the present disclosure. The computing system and devices may include any combination of hardware or software that can perform the indicated functions, including computers, network devices, internet appliances, PDAs, wireless phones, controllers, etc. The computing devices 140 may also be connected to other devices that are not illustrated, or instead may operate as a stand-alone system.

It is also noted that the computing device(s) 128 may be a component of the example correlated image acquisition system(s) 104, may be a separate device from the example correlated image acquisition system(s) 104 which is in communication with the example correlated image acquisition system(s) 104 via a network communication interface, or a combination thereof. For example, an example correlated image acquisition system(s) 104 may include a first computing device 128 that is a component portion of the example correlated image acquisition system(s) 104, and which acts as a controller that drives the operation of the example correlated image acquisition system(s) 104 (e.g., adjust the scanning location on the sample 106 by operating the scan coils, etc.). In such an embodiment the example correlated image acquisition system(s) 104 may also include a second computing device 140 that is desktop computer separate from the example correlated image acquisition system(s) 104, and which is executable to process data received from the microscope detection system 124 to generate images of the sample 106 and/or perform other types of analysis. The computing devices 140 may further be configured to receive user selections via a keyboard, mouse, touchpad, touchscreen, etc.

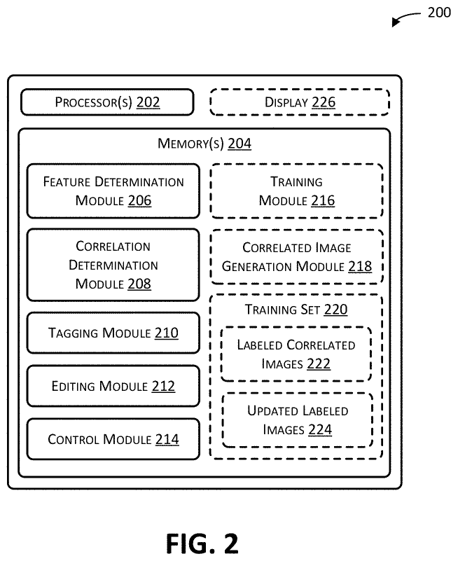

FIG. 2 is a schematic diagram illustrating an example computing architecture 200 for using, training, optimizing, and retraining supervised machine learning algorithms for use cases that involve correlated images. Example computing architecture 200 illustrates additional details of hardware and software components that can be used to implement the techniques described in the present disclosure. Persons having skill in the art would understand that the computing architecture 200 may be implemented in a single computing device or may be implemented across multiple computing devices. For example, individual modules and/or data constructs depicted in computing architecture 200 may be executed by and/or stored on different computing devices. In addition, the functionality provided by the illustrated components may in some implementations be combined in fewer components or distributed in additional components. Similarly, in some implementations, the functionality of some of the illustrated components may not be provided and/or other additional functionality may be available. In this way, different process steps of the inventive method according to the present disclosure may be executed and/or performed by separate computing devices.

In the example computing architecture 200, the computing device includes one or more processors 202 and memory 204 communicatively coupled to the one or more processors 202. The example computing architecture 200 can include a feature determination module 206, a correlation determination module 208, a tagging module 210, an editing module 212, an optional control module 214, an optional training module 216, and an optional correlated image generation module 218 stored in the memory 204.

The example computing architecture 200 is further illustrated as optionally including a training set 220 stored on memory 204. The training set 220 is a data structure (e.g., image, file, table, etc.) or collection of data structures that are used to one or more of the feature determination module 206, the correlation module 208, the tagging module, and/or component machine learning algorithms thereof.

For example, the training set 220 may include sets of labeled correlated images 222 that have been labeled and or otherwise had the features depicted therein associated with characteristic information. Individual correlated images sets correspond to a plurality of images of a sample or object of interest, where at least one or more image characteristics (e.g., depth, translational position, time, focus, etc.) are varied between the individual images of the series of images. For example, a correlated image set may correspond to a series of microscopy images of a cell culture at set imaging delays such that they collectively capture the growth of the cell culture over time. The labeled correlated images may have the component features they depict mapped, may identify relationships between related features in different images in the correlated image set, and may have characteristic information associated with individual features

As used herein, the term “module” is intended to represent example divisions of executable instructions for purposes of discussion and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of modules can be implemented in whole or in part by hardware (e.g., a specialized processing unit, etc.) to execute the described functions. As discussed above in various implementations, the modules described herein in association with the example computing architecture 200 can be executed across multiple computing devices.

The optional correlated image generation module 218 can be executable by the processors 202 to receive sensor data from imaging sensors (e.g., such as detector data from microscope detection system 124) of a correlated image acquisition system (e.g., correlated image acquisition system 104) and to generate a set of correlated images. For example, where the correlated image acquisition system includes a SEM column and a FIB column, the correlated image generation module 218 may use the sensor data to generate a plurality of images of a region of a sample, where each image is generated from sensor data generated during an individual imaging session by the SEM column, and where between each imaging session a portion of the sample is milled away by the FIB column. In this way, the correlated image generation module 218 may generate a set of correlated images where each image corresponds to a region of interest at a different depth within of the sample. In some embodiments, the images of the correlated image set are grayscale images that show contrasts indicative of the shape and/or the materials of the sample (e.g., a TEM lamella).

The feature determination module 206 can be executable by the processors 202 to identify the features depicted in individual images of a set of correlated images. In some embodiments, the set of correlated images are generated by the correlated image generation module 218. Alternatively, the set of correlated images may be transferred and stored on the memory 204 via a network connection (e.g., wireless network, Bluetooth, LAN, the internet, etc.) or a physical data transfer device (e.g., a thumb drive, a portable hard drive, CD-ROM, etc.).

The feature determination module 206 may comprise a trained machine learning module (e.g., an artificial neural network (ANN), convolutional neural network (CNN), Fully Convolution Neural Network (FCN) etc.) that is able to identify regions and/or key points within an image that correspond to/define features depicted within the image. For example, in some embodiments, the feature determination module 206 may identify the key points within the image by processing the image with a neural network (e.g., ANN, CNN, FCN, etc.) that outputs one or more coordinates of locations within the image that are predicted to correspond to key points/edges of features.

Alternatively, the feature determination module 206 may identify the key points within the images of the correlated image set by performing an image segmentation step. In the image segmentation step, the feature determination module 206 may segment the image into classes of associated pixels of the image. Example classes of associated pixels may include, but is not limited to a body of an object, a boundary of an object, surface structure of an object, component materials, component features, boundaries, foreground, background, etc. In some embodiments, the feature determination module 206 may further perform a key point identification step that determines regions of a segmented image where the segmentation indicates the presence of one or more features.

The correlation determination module 208 can be executable by the processors 202 to identify correlations between individual features depicted in a first image with individual features depicted in a second image of the correlated image set. Specifically, the correlation determination module 208 identifies regions of different images in the correlated image set that depict the same feature. For example, the correlation determination module 208 may determine relationships between the individual features depicted in an image with the corresponding locations of those same features in a subsequent and/or previous image in the correlated image set. In this way, the correlation determination module 208 is able to identify a location of a particular feature as it is depicted in a plurality of images in the correlated image set. In some embodiments, the correlation determination module 208 may comprise a trained machine learning module (e.g., an artificial neural network (ANN), convolutional neural network (CNN), Fully Convolution Neural Network (FCN) etc.) that is trained to identify such feature relationships between images in the correlated image set. s

The tagging module 210 can be executable by the processors 202 to label individual features depicted in the images of the correlated image set. This may correspond to adding the label information to the data file of the image itself (e.g., as metadata), adding the label information to a separate data file. An example separate data file may be a data file (e.g., a table) that identifies the features depicted by images within the correlated image set, relationships between those features, label information for the features, etc.

In some embodiments, the tagging module 210 may receive an input from a user that assigns a label to a feature depicted in an image of the correlated image set. For example, a user may interact with a graphical user interface (GUI) that allows them to select a feature that is present in an image of the correlated image set, and then assign a label (or another piece of characteristic information) to the feature. The GUI may be presented on a display 226 communicatively coupled with one or more of the processors 202.

Alternatively, or in addition, the tagging module 210 may be further executable to identify a corresponding label for a feature depicted in the correlated image set independent of a user input. For example, the tagging module 210 may comprise a trained machine learning module (e.g., an artificial neural network (ANN), convolutional neural network (CNN), Fully Convolution Neural Network (FCN) etc.) that is trained to assign labels to features based on their individual characteristics (e.g., size, shape, surrounding features, key points, texture, color, gradient, etc.) such feature relationships between images in the correlated image set.

In some embodiments, the tagging module 210 may use information in a data structure (e.g., table, model, expected feature map, feature characteristic table, etc.) to determine labels for individual features in the correlated image set. For example, the tagging model 210 may access a data structure that identifies labels and characteristic information for their associated features and use the characteristic information to identify and label features within individual images in the correlated image sets. In another example, where the images depict the structures of an object (e.g., a computer chip) at different depths, the tagging module 210 may access a labeled model of the object (e.g., a labeled CAD file) that shows the expected structures of the object and identifies their corresponding labels.

Additionally, the tagging module 210 may use the relationships determined by the correlation determination module 208 to label each instance of the selected feature throughout the correlated image set. In this way, a user may use the GUI to assign a label to a single instance of a feature as depicted in a single image of the correlated image set, and the tagging module 210 is executable to use the feature relationships to propagate the label to every occurrence of that feature within the correlated image set.

The editing module 212 can be executable by the processors 202 to allow a user to quickly and easily edit the labels assigned by the tagging module 210. The editing module 212 is executable to generate an editing GUI that allows a user to view images in the correlated image set, the features identified therein, and the label information for individual features. Where there is not a label associated with a feature, the editing GUI may be configured to present the user with an option for adding label information. The editing GUI further allows the user to select individual features and change the label information associated with the selected feature. For example, the editing GUI may allow the user to select a feature by clicking on the feature within a displayed image or hovering over the feature with a cursor. In some embodiments, in response to receiving a selection of a feature, the editing module 212 may cause the editing GUI to present information associated with the feature, present an option to change the label associated with the feature, or a combination thereof. The editing module 212 is further executable to use the feature relationships determined by the correlation determination module 208 to propagate the change to the other associated features in the correlate image set. In this way, the editing module 212 allows a user to correct multiple instances of an error within the correlated image set with a single selection. In this way, the editing module 212 enables a user to edit and/or verify the label information for an entire set of correlated images within a few minutes or less, saving tens to hundreds of user hours.

The editing GUI may allow the user to quickly browse the images of the correlated image set, the features therein, and their associated labels. For example, the editing GUI may display a plurality of thumbnail and/or otherwise reduced versions of images in the correlated image set so that the most or all of the images in the correlated image set can be viewed concurrently. In some embodiments, the editing GUI may be configured to receive a selection of an individual thumbnail and present an enlarged version of the associated image based on the selection. For example, the editing GUI may present an enlarged version of an image associated with a particular thumbnail based on a cursor hovering over the thumbnail.

In some embodiments, the editing GUI may further allow a user to review a particular desired feature as depicted within the correlated image set. In such embodiments, the editing GUI may allow the user to select a desired feature, and the editing module 212 may cause the editing GUI to present a plurality of thumbnails and/or reduced versions of portions of the images in the correlated image set that contain the desired feature. For example, may identify the location of the desired feature within individual images of the correlated image set, may crop the images around the desired feature, and then present the cropped images. In some embodiments the editing module 212 may align the desired feature as depicted in each cropped image so that the desired feature is presented in a consistent location across each of the thumbnails. In this way, the editing GUI enables the user to quickly review each of the occurrences of the desired features throughout the correlated image set.

Additionally, in some embodiments the editing GUI further allows the user to change the feature relationships identified by the correlation determination module 208. For example, the GUI may present a user with one or more visual elements that allow the user to indicate that a relationship between two associated features in the correlated image set is incorrect, and/or allow the user to create new relationships for one or more selected feature(s).

The editing module 212 may be further executable to generate updated labeled images 224 based on the edits received via the editing GUI. Such updated labeled images 224 can then be used to retrain or otherwise optimize one or more of the feature determination module 206, the correlation determination module 208, and the tagging module 210. In this way, in addition to drastically increasing the speed and ease of reviewing the label information for a set of correlated images, as the user reviews the outputs of the feature determination module 206, the correlation determination module 208, and the tagging module 210 the editing module 212 systematically retrains these algorithms to obtain results that more closely align with the desires of the user (i.e., conducts supervised training of the algorithms to align with the user's desired functionalities). Thus, the editing module 212, in combination with the other modules present on the memory 204 removes the time and expertise barriers that currently limit the ability of users to employ supervised machine learning algorithms.

The computing architecture 200 may optionally include a training module 216 that is executable to train one or more of the feature determination module 206, the correlation determination module 208, the tagging module 210, a combination thereof, and/or component machine learning algorithm(s) thereof based on the labeled correlated images 222. Moreover, the training module 216 may be further configured to perform additional training with updated labeled images 224. In this way, the training module 216 may retrain one or more of the feature determination module 206, the correlation determination module 208, the tagging module 210, a combination thereof, and/or component machine learning algorithm(s) thereof to more reliably provide functionality that aligns to the particular use case/desired output of a particular user.

The control module 214 can be executable by the processors 202 to cause a computing device 140 and/or correlated image acquisition system (e.g., example correlated image acquisition system 104) to take one or more actions. For example, the control module 214 may cause the example correlated image acquisition system 104 to cause the sample holder 136 or sample manipulation probe 138 to apply a translation, tilt, rotation, or a combination thereof to the sample 106. In such examples the control module 214 may further cause one of the SEM column 108 or the FIB column 110 to image, scan, mill, or otherwise irradiate portions of the sample 106.

As discussed above, the computing architecture 200 includes one or more processors 202 configured to execute instructions, applications, or programs stored in a memory(s) 204 accessible to the one or more processors. In some examples, the one or more processors 202 may include hardware processors that include, without limitation, a hardware central processing unit (CPU), a graphics processing unit (GPU), and so on. While in many instances the techniques are described herein as being performed by the one or more processors 202, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memories 204 accessible to the one or more processors 202 are examples of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer executable instructions that, when executed by one or more processing units, cause various functions and/or operations described herein to be performed. In contrast, communication media embodies computer-readable instructions, data structures, program modules, or other data in a modulated data signal, such as a carrier wave, or other transmission mechanism. As defined herein, computer storage media does not include communication media.

Those skilled in the art will also appreciate that items or portions thereof may be transferred between memory 204 and other storage devices for purposes of memory management and data integrity. Alternatively, in other implementations, some or all of the software components may execute in memory on another device and communicate with the computing devices. Some or all of the system components or data structures may also be stored (e.g., as instructions or structured data) on a non-transitory, computer accessible medium or a portable article to be read by an appropriate drive, various examples of which are described above. In some implementations, instructions stored on a computer-accessible medium separate from the computing devices may be transmitted to the computing devices via transmission media or signals such as electrical, electromagnetic, or digital signals, conveyed via a communication medium such as a wireless link. Various implementations may further include receiving, sending or storing instructions and/or data implemented in accordance with the foregoing description upon a computer-accessible media.

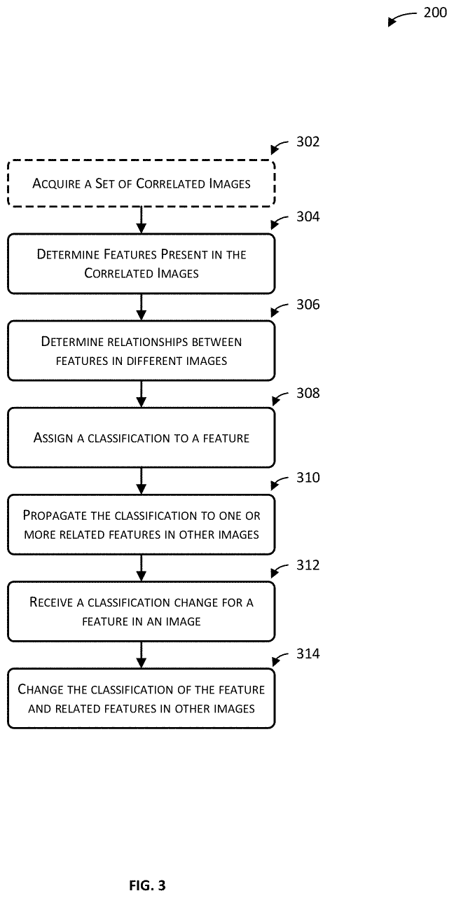

FIG. 3 is a flow diagram of illustrative processes depicted as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

Specifically, FIG. 3 is a flow diagram of an illustrative process 300 for using, training, optimizing, and retraining supervised machine learning algorithms for use cases that involve correlated images. The process 300 may be implemented in environment 100 and/or by one or more computing device(s) 140, and/or by the computing architecture 200, and/or in other environments and computing devices.

At 302, a set of correlated images is optionally acquired. In some embodiments, the set of correlated images may be transferred and stored on an accessible memory by a network connection (e.g., wireless network, Bluetooth, LAN, the internet, etc.) or a physical data transfer device (e.g., a thumb drive, a portable hard drive, CD-ROM, etc.). Alternatively, the set of correlated images are generated based on sensor data from imaging sensors of a correlated image acquisition system. For example, where the correlated image acquisition system is a microscope system, the correlated images may be generated based on image sensor data taken at a plurality of sample times, wherein between each sample time a set time duration lapses and/or the sample is translated a known distance from the prior sample time.

At 304, features present in the correlated images are determined. For example, a trained machine learning module (e.g., an artificial neural network (ANN), convolutional neural network (CNN), Fully Convolution Neural Network (FCN) etc.) may be used to identify regions and/or key points within an image that correspond to/define features depicted within the images of the correlated image set. For example, in some embodiments, the feature determination module 206 may identify the key points within the image by processing the image with a neural network (e.g., ANN, CNN, FCN, etc.) that performs image segmentation, where the images is segmented into classes of associated pixels of the image. Example classes of associated pixels may include, but is not limited to a body of an object, a boundary of an object, surface structure of an object, component materials, component features, boundaries, foreground, background, etc.

At 306, a relationship between features in different images is determined. That is, instances where the same feature is depicted in multiple images in the correlated image set are determined, and each instance of that same feature is associated with each other. In some embodiments, a trained machine learning module (e.g., an artificial neural network (ANN), convolutional neural network (CNN), Fully Convolution Neural Network (FCN) etc.) may identify relationships between a same feature as depicted in different images in the correlated image set.

At 308, a classification is assigned to a feature. Assigning the classification may correspond to applying label information to the data file of the image itself (e.g., as metadata), or adding the label information to a separate data file that identifies the features depicted by images within the correlated image set, relationships between those features, label information for the features, etc.

In some embodiments, the classification may be assigned based on an input from a user that assigns a label to a feature depicted in an image of the correlated image set. For example, a user may interact with a graphical user interface (GUI) that allows them to select a feature that is present in an image of the correlated image set, and then assign a label (or another piece of characteristic information) to the feature. Alternatively or in addition, the classification may be assigned by an algorithm and/or trained machine learning module (e.g., an artificial neural network (ANN), convolutional neural network (CNN), Fully Convolution Neural Network (FCN) etc.) that is trained to assign labels to features based on their individual characteristics (e.g., size, shape, surrounding features, key points, texture, color, gradient, etc.) such feature relationships between images in the correlated image set. For example, the algorithm and/or trained machine learning module may use information in a data structure (e.g., table, model, expected feature map, feature characteristic table, etc.) to determine labels for individual features in the correlated image set.

At 310, the classification is propagated to one or more related features in other images. The relationships determined in step 306 to label each instance of the selected feature throughout the correlated image set. In this way, a user may use the GUI to assign a label to a single instance of a feature as depicted in a single image of the correlated image set, and the label is propagated to every occurrence of that feature within the correlated image set.

At 312, a change to classification for a particular feature in an image is received. An editing GUI is displayed that allows the user to view images in the correlated image set, the features identified therein, and the label information for individual features. Where there is not a label associated with a feature, the editing GUI may be configured to present the user with an option for adding label information. The editing GUI further allows the user to select individual features and change the label information associated with the selected feature. For example, the editing GUI may allow the user to select a feature by clicking on the feature within a displayed image or hovering over the feature with a cursor.

At 314, the change to the classification is applied to the particular feature and propagated to one or more related features in other images. The change is propagated to the one or more related features using the relationships determined in step 306. In this way, the user is able to correct multiple instances of an error within the correlated image set with a single selection, reducing the time necessary to edit and/or verify the label information for an entire set of correlated images from hundreds of user hours down to a few minutes or less.

FIG. 4 is a diagram that illustrate sample process 400 for using, training, optimizing, and retraining supervised machine learning algorithms for use cases that involve correlated images. Specifically, FIG. 4 shows a graphical depiction of an example execution of the process shown in FIG. 3 for a plurality of correlated images of a region of interest on a lamellae, where between each image a layer of the lamellae is removed.

Image 402 shows the set of correlated images of a region of interest on a lamellae formed from a semiconductor chip. Image 402 shows the correlated images as including three images, however any number of images may be included in the set. Individual images are shown as being grayscale images generated using a charged particle microscope system. Between the acquisition of each image in the set of correlated images a layer of the lamellae is milled away using a laser or focused ion beam. Image 404 illustrates the set of correlated images after the features 406 depicted within the image are determined by a feature determination algorithm.

Image 408 shows the relationships between the features depicted in an individual image and the features depicted in other images in the correlated image set. Specifically, image 408 shows a graphical depiction of this relationships where each unique feature is associated with a letter. In this way, features that correspond to one another are labeled with the same letter across the entire correlated image set. In some embodiments, the relationships are generated using a correlation determination algorithm.

Image 410 shows characterization information being associated with a first image 412 of the correlated image set. The characterization information is graphically shown in Image 410 by the patterning of the corresponding feature as depicted in the first image 412. Example characterization information may include a type, name, label, composition, or other information. In various embodiments of the disclosed invention, the characterization may be assigned to the features in the first image 412 by a computer algorithm (e.g., a machine learning algorithm), by user input (e.g., via a GUI or voice command), or a combination thereof (e.g., an algorithm selects one or more best guesses which are verified by a user selection).

FIG. 414 shows the correlated image set after the characterization information associated with the features in the first image 412 is propagated to related features in the image set. This propagation is performed by a tagging algorithm that uses the relationships (represented by letters in FIG. 4) to ensure that each occurrence of a unique feature within the correlated image set is tagged with corresponding characterization information. FIG. 414 visually illustrates this by having each feature associated with a letter as having the same patterning.

Image 416 shows an edit being made to the characterization information associated with a features 418. For example, a user may input the change during a review procedure conducted via an editing GUI. FIG. 20 shows the edit to feature 418 being propagated to each occurrence of the feature (i.e., feature E) in the correlated image set. The edit is propagated using the feature relationships.

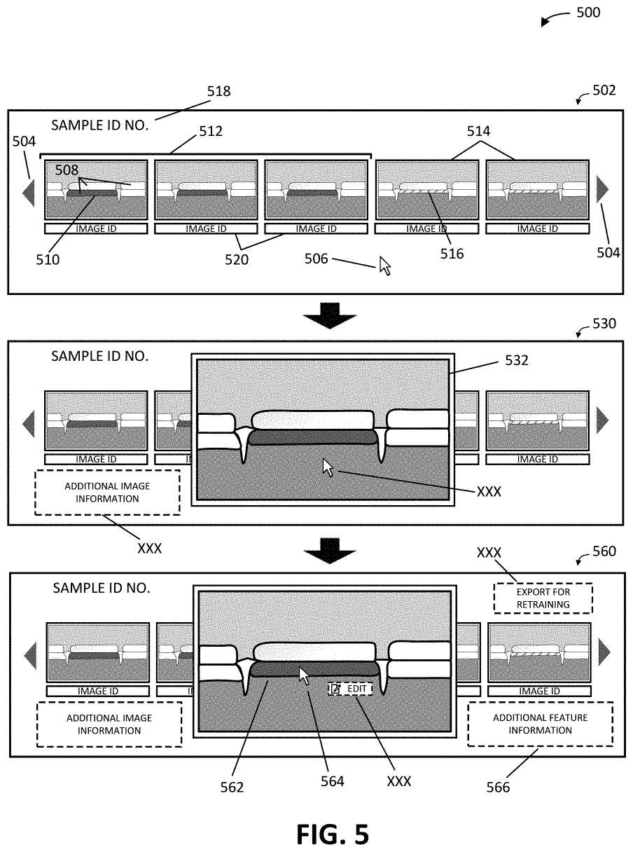

FIGS. 5 and 6 are diagrams that illustrate example editing GUIs 500 and 600 for quickly and easily reviewing algorithm output, correcting errors, and generating additional training data for the algorithm.

FIG. 5 shows a first example editing GUI 500 according to the present disclosure. Specifically, FIG. 5 shows three images of the example editing GUI 500 that illustrate a first example process that allows a user to quickly and easily review characterization information for a set of correlated images.

Image 502 shows the editing GUI 500 when no individual image of the correlated image set is selected for review. In some embodiments, when not selected for review the individual correlated images of the set are shown as reduced size/thumbnail versions. When the entire set of correlated images cannot fit into the editing GUI 500, the editing GUI 500 may include selectable elements 504 that allow a user to change the subset of the correlated image set that is displayed. Such selectable elements 504 may include selectable icons, dropdown menus, scroll bars, search boxes, etc. that will be known in the art. FIG. 5 illustrates the selectable elements 504 as being icons that change the images displayed by the GUI 500 with a user selects and/or hovers over the icons with a cursor 506.

For ease of understanding, the correlated image set depicted in FIG. 5 corresponds to the correlated image set depicted in FIG. 4. However, the editing GUI 500 can be used with any set of correlated images labeled according to the present disclosure and is not limited to use with correlated images acquired with a charged particle microscope system.

In FIG. 5, each image of the correlated set of images depicts a plurality of features 508 that have been previously identified an interrelated using processes according to the present disclosure. In example editing GUI 500, only characterization information for a selected feature 510 is graphically illustrated. However, in other embodiments, some or all of the other features 508 may be displayed in a way that graphically shows their corresponding characterization information. Image 502 shows the selected feature as being present in a plurality of initial images 512, but not being present in subsequent images 514. In subsequent images 514 an unrelated feature 516 is shown. As the correlated image set shown in editing GUI 500 corresponds to a set of correlated images of a lamellae where a layer of the lamellae is milled away between images, feature 508 ceasing to be displayed means that at a certain depth associated with the transition between images 512 and images 514 the feature 508 ceases to be present in the lamellae. Image 502 also shows the editing GUI 500 as displaying a set identifier 518 for the correlated image set and individual image identifiers 520 for each displayed image.

Image 530 shows the editing GUI 500 after a particular image of the correlated image set has been selected. When a selection of the particular image is received from a user, an enlarged version 532 of the image is presented on the editing GUI 500. In an example embodiment, selecting the particular image may correspond to a user clicking or hovering over a thumbnail or image identifier associated with the particular image using a cursor 534. In some embodiments, in addition to displaying an enlarged version 532 of the particular image, the editing GUI 500 may also show additional image information 536 in response to receiving a selection of the particular image.

Image 560 shows the editing GUI 500 after a particular feature 562 within the enlarged image of the correlated image set has been selected. In an example embodiment, selecting the particular feature 562 may correspond to a user clicking or hovering over a thumbnail or image identifier associated with the particular image using a cursor 564. In some embodiments, in response to receiving a selection of the particular feature 562 the editing GUI 500 may graphically change the presentation of the particular feature 562 (e.g., enlarge, embolden, etc.), present additional feature information 566, or both. Alternatively, or in addition, upon receiving a selection of the particular feature 562, the editing GUI 500 may present the user with a selectable tool 568 for editing the characteristic information of the particular feature 562. A person having skill in the art will understand that the selectable tool 568 may correspond to any of a dropdown menu, a selectable icon, a typed shortcut, a voice command, or other user input that is designed to indicate a desire to edit the characterization information about the particular feature 562. In various embodiments, editing the characteristic information may correspond to changing the characteristic assigned to the particular feature 562, or changing a relationship between the particular feature 562 and other features in the correlated image set. In some embodiments, the editing GUI 500 may present a selectable option 570 to retrain one or more of a feature determination algorithm, a relationships determination algorithm, and a tagging algorithm based on the change to the characteristic information for the particular feature 562. In this way, the modified labels/characterization information for the correlated image set can be used to retrain one or more machine learning components such that their performance more closely aligns with the desires of the user. Thus, in addition to speeding up the process of reviewing/editing a correlated image set that is labeled using a machine learning algorithm, the editing GUI 500 also makes it easy for a user to train a supervised machine learning algorithm to perform his or her desired function.

FIG. 6 shows a second example editing GUI 600 according to the present disclosure. Specifically, FIG. 6 shows three images of the example editing GUI 600 that illustrate a second example process that allows a user to quickly and easily review characterization information for a set of correlated images.

Image 602 shows the editing GUI 600 when no individual image of the correlated image set is selected for review. In FIG. 6, when not selected the editing GUI 600 displays a cropped version of each image in the correlated image set. Specifically, FIG. 6 shows an embodiment of example GUI 600 where the correlated images are cropped and align to allow for quick any easy review of a particular feature 604 of the correlated image set, that has been previously identified an interrelated using processes according to the present disclosure. In example editing GUI 600, only characterization information for a selected feature 604 is graphically illustrated. However, in other embodiments, some or all of the other features may be displayed in a way that graphically shows their corresponding characterization information.

In some embodiments, as part of generated the example GUI 600, an associated computing device may receive a selection of the particular feature 604, may identify the location of the particular feature 604 in individual images, crop the individual images based on the location of the particular feature 604, and align the cropped versions of the image so that the feature is presented in a consistent way in each of the cropped version presented by the editing GUI 600. When cropped versions of the entire set of correlated images cannot fit into the editing GUI 600, the editing GUI 600 may include selectable elements 606 that allow a user to change the subset of the correlated image set that is displayed. Such selectable elements 606 may include selectable icons, dropdown menus, scroll bars, search boxes, etc. that will be known in the art. FIG. 6 illustrates the selectable elements 606 as being icons that change the images displayed by the GUI 600 with a user selects and/or hovers over the icons with a cursor 608.

For ease of understanding, the correlated image set depicted in FIG. 6 corresponds to the correlated image set depicted in FIGS. 4 and 5. However, the editing GUI 600 can be used with any set of correlated images labeled according to the present disclosure, and is not limited to use with correlated images acquired with a charged particle microscope system.

Image 602 shows the particular feature 604 as being present in a plurality of initial images 610, but not being present in images 612. In images 612 an unrelated feature 614 is shown. As the correlated image set shown in editing GUI 600 corresponds to a set of correlated images of a lamellae where a layer of the lamellae is milled away between images, feature 604 ceasing to be displayed means that at a certain depth associated with the transition between images 610 and images 612 the feature 604 ceases to be present in the lamellae. Image 602 also shows the editing GUI 600 as displaying a set identifier 616 for the correlated image set and individual image identifiers 618 for each displayed image.

Image 630 shows the editing GUI 600 after a particular image of the correlated image set has been selected. When a selection of the particular image is received from a user, an enlarged version 632 of the image is presented on the editing GUI 600. In an example embodiment, selecting the particular image may correspond to a user clicking or hovering over a thumbnail or image identifier associated with the particular image using a cursor 634. In some embodiments, in addition to displaying an enlarged version 632 of the particular image, the editing GUI 600 may also show additional image information 636 in response to receiving a selection of the particular image.

Image 660 shows the editing GUI 600 after a particular feature 662 within the enlarged image of the correlated image set has been selected. In an example embodiment, selecting the particular feature 662 may correspond to a user clicking or hovering over a thumbnail or image identifier associated with the particular image using a cursor 664. In some embodiments, in response to receiving a selection of the particular feature 662 the editing GUI 600 may graphically change the presentation of the particular feature 662 (e.g., enlarge, embolden, etc.), present additional feature information 666, or both. Alternatively, or in addition, upon receiving a selection of the particular feature 662, the editing GUI 600 may present the user with a selectable tool 668 for editing the characteristic information of the particular feature 662. A person having skill in the art will understand that the selectable tool 668 may correspond to any of a dropdown menu, a selectable icon, a typed shortcut, a voice command, or other user input that is designed to indicate a desire to edit the characterization information about the particular feature 662. In various embodiments, editing the characteristic information may correspond to changing the characteristic assigned to the particular feature 662, or changing a relationship between the particular feature 662 and other features in the correlated image set.

Examples of inventive subject matter according to the present disclosure are described in the following enumerated paragraphs.

A1. A method for labeling a plurality of correlated images of a sample, comprising: acquiring a plurality of correlated images of the sample; determining one or more features in each image of the plurality of correlated images; determining a relationship between at least a first feature in a first image of the plurality of correlated images and at least a second feature in a second image of the plurality of images; determining a characteristic information associated with the first feature; and associating the second feature in the second image with the characteristic information based on the relationship.

A2. The method of paragraph A1, wherein acquiring the plurality of correlated images of the sample comprises one of: importing the plurality of correlated images; and generating the plurality of correlated images with a correlated image acquisition system.

A2.1. The method of paragraph A2, wherein generating the plurality of correlated images with the correlated image acquisition system comprises generating a series of images of a sample over time.

A2.2. The method of any of paragraphs A2-A2.1, wherein a set time period occurs between the generation of each image of the series of images.

A2.3. The method of any of paragraphs A2-A2.2, wherein the sample is translated and/or rotated between the generation of each image of the series of images.

A2.4. The method of any of paragraphs A2-A2.3, wherein a portion of the sample is removed between the generation of each image of the series of images.

A2.4.1. The method of paragraph A2.4, wherein the portion of the sample is removed with one of a charged particle beam or laser.

A2.4.1.1. The method of paragraph A2.4.1, wherein the charged particle beam is an ion beam.

A2.5. The method of any of paragraphs A2-A2.4.1.1, wherein the correlated image acquisition system is a charged particle microscope.

A3. The method of any of paragraphs A1-A2.5, wherein the one or more features in each image are determined using one or more machine learning algorithms.

A3.1. The method of paragraphs A3, wherein the machine learning algorithms include a supervised machine learning algorithm.

A4. The method of any of paragraphs A1-A3.1, wherein determining the relationships comprises determining that the first feature in the first image and the second feature in the second image depict a same component of the sample.

A4.1. The method of paragraphs A4, wherein determining the relationships comprises further determining one or more additional features in the correlated image set that depict the same component of the sample.

A4.2. The method of any of paragraphs A4-A4.1, wherein the relationships between the first feature in the first image and the second feature in the second image is determined using one or more machine learning algorithms.

A4.3. The method of any of paragraphs A1-A2.5, wherein determining the relationships further comprises determining an additional relationship between a third feature in the first image and a fourth feature in the second image.

A4.3.1. The method of paragraphs A4.3, wherein determining the additional relationship comprises determining that the third feature in the first image and the fourth feature in the second image depict an additional same component of the sample.

A4.4. The method of any of paragraphs A4-A4.3.1, wherein the relationships are determined by one or more machine learning algorithms.

A4.4.1. The method of paragraphs A4.4, wherein the machine learning algorithms include a supervised machine learning algorithm.

A5. The method of any of paragraphs A1-A4.4.1, wherein determining a characteristic information associated with the first feature comprises receiving a user input that indicates the characteristic information.

A5.1. The method of paragraph A5, wherein receiving the user input comprises: presenting a GUI that graphically displays the first feature in the first image; receiving a selection of the first feature via the GUI; and receiving a selection of the characteristic information associated with the first feature.

A5.2. The method of any of paragraphs A5-A5.1, wherein determining a characteristic information associated with the first feature comprises accessing a data structure that describes one or more components of the sample, and characteristic information for the one or more components of the sample.

A5.2.1. The method of paragraph A5.2, wherein the data structure is one of a table, a model, and/or metadata thereof.

A5.2.2. The method of any of paragraphs A5.2-A5.2.1, wherein associating characteristic information associated with the first feature comprises mapping a component of the sample described in the data structure to the first feature in the first image.

A5.2.2.1. The method of paragraph A5.2.2, wherein the characteristic information associated with the first feature are associated by one or more machine learning algorithms.

A6. The method of any of paragraphs A1-A5.2.2.1. wherein the correlated image set corresponds to a plurality of sequentially related images.

A6.1. The method of paragraph A6, wherein determining the relationships comprises determining one or more relationships between features in sequential images.

A7. The method of any of paragraphs A1-A6.1, wherein the sample is a lamella.

A8. The method of any of paragraphs A1-A6.1, wherein the sample is at least a portion of a semiconductor.

A9. The method of any of paragraphs A1-A6.1, wherein the sample is a biological sample.

A10. The method of any of paragraphs A1-A6.1, wherein the sample is a plurality of cells.

A11. The method of any of paragraphs A1-A10, further comprising receiving an edit to one of: the characteristic information associated with the first feature; and the relationship.

A11.1. The method of paragraph A11, wherein the edit comprises a change to the characteristic information associated with the first feature, and the method further comprises associating the second feature in the second image with the change to the characteristic information based on the relationship.

A11.2. The method of any of paragraphs A11-A11.1, wherein the edit comprises a change to the relationship, and wherein the method further comprises changing the characteristic information associated with the second feature in the second image based on the edit.

A11.3. The method of any of paragraphs A11-A11.2, wherein the edit comprises a change to the relationship, and wherein the method further comprises associating a third feature in a third image of the plurality of correlated images with the characteristic information based on the change to the relationship.

A11.4. The method of any of paragraphs A11-A11.3, wherein receiving an input comprises presenting, on a display, a graphical user interface (GUI) that allows a user to review the plurality of correlated images of the sample.

A11.4.1. The method of paragraph A11.4, wherein the GUI comprises a selectable element that allows the edit to be input.

A11.4.2. The method of any of paragraphs A11.4-A11.4.1, wherein the GUI is configured to: display smaller graphical representations of at least the first image and the second image; and responsive to receiving a user input selection of the first image, display a larger graphical representation of the first image.

A11.4.2.1. The method of paragraph A11.4.2, wherein the smaller graphical representations correspond to one or more of a lower resolution versions, a cropped versions, and/or a smaller sized versions of the first image and the second image.

A11.4.2.2. The method of any of paragraphs A11.4.2-A11.4.2.1, wherein the larger graphical representation of the first image corresponds to a graphical representation that is a higher resolution, an uncropped version, and/or a larger version of the smaller graphical representation of the first image.

A11.4.2.3. The method of any of paragraphs A11.4.2-A11.4.2.2, wherein the smaller graphical representations of at least the first image and the second image are cropped versions of the first image and second image that include the first feature and the second feature, respectively.

A11.4.2.3.1. The method of paragraph A11.4.2.3, wherein the smaller graphical representations of at least the first image and the second image are positioned in the GUI so that the first feature is aligned with the second feature.

A11.4.2.3.1.1. The method of paragraph A11.4.2.3.1, when dependent from paragraphs A4.2, wherein the GUI further includes a smaller graphical representation of the third image that is cropped to include the third feature, and wherein the smaller graphical representations of the first image, the second image, and the third image are positioned in the GUI so that the first feature, the second feature, and the third feature are aligned.

A11.4.2.3.1.2. The method of any of A11.4.2.3.1-A11.4.2.3.1.1, further comprising receiving a user input selection of the first feature, wherein the positioning of the smaller graphical representations of the first image, the second image, and the third image such that the first feature, the second feature, and the third feature are aligned is based on the user selection of the first feature.

A11.4.2.4. The method of any of paragraphs A11.4.2-A11.4.2.3.1.1, wherein receiving the user input selection of the first image comprises a cursor selecting and/or hovering over the smaller graphical representation of the first image

A11.4.2.4.1. The method of paragraph A11.4.2.4, further comprising, in response to receiving information that the cursor is no longer hovering over the larger graphical representation of the first image, causing the GUI to no longer display the larger graphical representation of the first image.

A11.4.2.4.2. The method of paragraph A11.4.2.4, further comprising, in response to receiving information that the cursor has selected a different graphical representation of a different image, causing the GUI to no longer display the larger graphical representation of the first image.

A11.4.2.5. The method of any of paragraphs A11.4.2-A11.4.2.4.2, further comprising receiving a selection of the first feature in the larger graphical representation of the first image.

A11.4.2.5.1. The method of paragraph A11.4.2.5, wherein based on the selection of the first feature in the larger graphical representation of the first image, causing the GUI to present one or more of: the selectable element that allows the edit to be input; a graphical representation of the characteristic information associated with the first feature.

A11.4.2.6. The method of any of paragraphs A11.4.2-A11.4.2.5.1, wherein presenting the larger graphical representation of the first image comprises presenting a graphical representation of the characteristic information associated with the first feature.

A11.4.2.7. The method of any of paragraphs A11.4.2-A11.4.2.6, wherein presenting the smaller graphical representations of the first image and the second image comprises presenting graphical representations of the characteristic information associated with the first feature and the second feature.

A11.5. The method of any of paragraphs A11-A11.4.2.7, wherein based at least in part on receiving the edit, generating an updated training data set based on the edit and the correlated image set for training a machine learning algorithm.

B1. A method for reviewing a labels set of correlated images, the method comprising: presenting, on a display, a graphical user interface that allows a user to review the plurality of correlated images of a sample that is generated at least partially using any of the methods described in paragraphs A1-A10.

B1.1. The method of paragraph B1.4, wherein the GUI comprises a selectable element that allows a user to input an edit to one of: the characteristic information associated with the first feature; and the relationship.

B1.1.1. The method of paragraph B1.1, wherein the edit comprises a change to the characteristic information associated with the first feature, and the method further comprises associating the second feature in the second image with the change to the characteristic information based on the relationship.

B1.1.2. The method of any of paragraphs B1.1-B1.1.1, wherein the edit comprises a change to the relationship, and wherein the method further comprises changing the characteristic information associated with the second feature in the second image based on the edit.

B1.1.3. The method of any of paragraphs B1-1.1.2, wherein the edit comprises a change to the relationship, and wherein the method further comprises associating a third feature in a third image of the plurality of correlated images with the characteristic information based on the change to the relationship.

B1.2. The method of any of paragraphs B1-1.1, wherein the GUI is configured to: display smaller graphical representations of at least the first image and the second image; and responsive to receiving a user input selection of the first image, display a larger graphical representation of the first image.

B1.2.1. The method of paragraph B1.2, wherein the smaller graphical representations correspond to one or more of a lower resolution versions, a cropped versions, and/or a smaller sized versions of the first image and the second image.

B1.2.2. The method of any of paragraphs B1.2-B1.2.1, wherein the larger graphical representation of the first image corresponds to a graphical representation that is a higher resolution, an uncropped version, and/or a larger version of the smaller graphical representation of the first image.

B1.2.3. The method of any of paragraphs B1.2-B1.2.2, wherein the smaller graphical representations of at least the first image and the second image are cropped versions of the first image and second image that include the first feature and the second feature, respectively.

B1.2.3.1. The method of paragraph B1.2.3, wherein the smaller graphical representations of at least the first image and the second image are positioned in the GUI so that the first feature is aligned with the second feature.

B1.2.3.1.1. The method of paragraph B1.2.3.1, when dependent from paragraphs A4.2, wherein the GUI further includes a smaller graphical representation of the third image that is cropped to include the third feature, and wherein the smaller graphical representations of the first image, the second image, and the third image are positioned in the GUI so that the first feature, the second feature, and the third feature are aligned.

B1.2.3.1.2. The method of any of B1.2.3.1-B1.2.3.1.1, further comprising receiving a user input selection of the first feature, wherein the positioning of the smaller graphical representations of the first image, the second image, and the third image such that the first feature, the second feature, and the third feature are aligned is based on the user selection of the first feature.

B1.2.4. The method of any of paragraphs B1.2-B1.2.3.1.1, wherein receiving the user input selection of the first image comprises a cursor selecting and/or hovering over the smaller graphical representation of the first image

B1.2.4.1. The method of paragraph B1.2.4, further comprising, in response to receiving information that the cursor is no longer hovering over the larger graphical representation of the first image, causing the GUI to no longer display the larger graphical representation of the first image.

B1.2.4.2. The method of paragraph B1.2.4, further comprising, in response to receiving information that the cursor has selected a different graphical representation of a different image, causing the GUI to no longer display the larger graphical representation of the first image.

B1.2.5. The method of any of paragraphs B1.2-B1.2.4.2, further comprising receiving a selection of the first feature in the larger graphical representation of the first image.

B1.2.5.1. The method of paragraph B1.2.5, wherein based on the selection of the first feature in the larger graphical representation of the first image, causing the GUI to present one or more of: the selectable element that allows the edit to be input; a graphical representation of the characteristic information associated with the first feature.

B1.2.6. The method of any of paragraphs B1.2-B1.2.5.1, wherein presenting the larger graphical representation of the first image comprises presenting a graphical representation of the characteristic information associated with the first feature.

B1.2.7. The method of any of paragraphs B1.2-B1.2.6, wherein presenting the smaller graphical representations of the first image and the second image comprises presenting graphical representations of the characteristic information associated with the first feature and the second feature.

C1. A computing system configured to perform any of the methods of paragraphs A1-A11.5 or B1-B1.2.7.

D1. Use of the computing system of paragraph C1 to perform any of the methods of paragraphs A1-A11.5 or B1-B1.2.7.

E1. A non-transitory computer readable media that contains instructions that, when executed by one or more processors, cause the computing system of paragraph C1 to perform any of the methods of paragraphs A1-A11.5 or B1-B1.2.7.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “determine,” “identify,” “produce,” and “provide” to describe the disclosed methods. These terms are high-level abstractions of the actual operations that are performed. The actual operations that correspond to these terms will vary depending on the particular implementation and are readily discernible by one of ordinary skill in the art.

What is claimed is:

1. A method for labeling a plurality of correlated images of a sample, comprising:
acquiring a plurality of correlated images of the sample with a charged particle microscope system;
determining one or more features in one or more images of the plurality of correlated images;
determining a relationship between a first feature in a first image of the plurality of correlated images and a second feature in a second image of the plurality of images, wherein the relationship indicates that the first feature and the second feature correspond to a same component of the sample;
determining a characteristic information associated with the first feature; and
associating the second feature in the second image with the characteristic information based on the relationship.

2. The method of claim 1, wherein the sample is a lamellae formed from a semiconductor chip, wherein each image of the plurality of correlated images is acquired using an electron microscope, and wherein between the acquisition of each image a portion of the sample is removed with a focused ion beam.

3. The method of claim 2, further comprising:
presenting, on a display, a graphical user interface (GUI) that includes a selectable element that allows a user to input an edit to the characteristic information associated with the first feature;
receiving, via the selectable element, an edit that comprises a change to the characteristic information associated with the first feature; and
associating the second feature in the second image with the change to the characteristic information based on the relationship.

4. The method of claim 3, wherein at least one of the determinations is performed by one or more machine learning algorithms, and wherein based at least in part on receiving the edit, generating an updated training data set based on the edit and the correlated image set for the training for the one or more machine learning algorithms.

5. A method for labeling a plurality of correlated images of a sample, comprising:
acquiring a plurality of correlated images of the sample;
determining one or more features in each image of the plurality of correlated images;
determining a relationship between at least a first feature in a first image of the plurality of correlated images and at least a second feature in a second image of the plurality of correlated images;
determining a characteristic information associated with the first feature; and
associating the second feature in the second image with the characteristic information based on the relationship.

6. The method of claim 5. wherein the correlated image set corresponds to a plurality of sequentially related images of the sample, and wherein determining the relationships comprises determining one or more relationships between features in sequential images.

7. The method claim 5, wherein a portion of the sample was removed between a first time when the first image was generated and a second time when the second image was generated.

8. The method of claim 5, wherein determining the relationships comprises determining that the first feature in the first image and the second feature in the second image depict a same component of the sample.

9. The method of claim 5, wherein determining the relationships further comprises determining an additional relationship between a third feature in the first image and a fourth feature in the second image.

10. The method of claim 9, wherein determining the additional relationship comprises determining that the third feature in the first image and the fourth feature in the second image depict an additional same component of the sample.

11. The method of claim 5, wherein the relationships are determined at least in part by a supervised machine learning algorithm.

12. The method of claim 5, wherein determining the characteristic information associated with the first feature comprises:
presenting a GUI that graphically displays the first feature in the first image
receiving a selection of the first feature via the GUI; and
receiving a selection of the characteristic information associated with the first feature.

13. The method of claim 5, wherein the determination of the characteristic information associated with the first feature is performed at least in part by an algorithm accessing a data structure that describes one or more components of the sample and characteristic information for the one or more components of the sample.

14. The method of claim 5, further comprising:
receiving an edit that comprises a change to the relationship; and
associating a third feature in a third image of the plurality of correlated images with the characteristic information based on the change to the relationship.

15. The method of claim 5, further comprising:
receiving an edit that comprises a change to the characteristic information associated with the first feature; and
associating the second feature in the second image with the change to the characteristic information based on the relationship.

16. The method of claim 15, wherein receiving the edit comprises presenting, on a display, a graphical user interface (GUI) that includes a selectable element that allows a user to input the edit to the characteristic information associated with the first feature.

17. The method of claim 16, wherein the GUI is configured to:
display smaller graphical representations of at least the first image and the second image; and
responsive to receiving a user input selection of the first image, display a larger graphical representation of the first image.

18. The method of claim 17, wherein the smaller graphical representations of at least the first image and the second image are cropped versions of the first image and second image that include the first feature and the second feature, and wherein the smaller graphical representations of at least the first image and the second image are positioned in the GUI so that the first feature is aligned with the second feature.

19. The method of claim 17, wherein receiving the user input selection of the first image comprises a cursor selecting or hovering over the smaller graphical representation of the first image; and wherein the GUI is further configured to no longer display the larger graphical representation of the first image in response to receiving information that the cursor is no longer hovering over the larger graphical representation of the first image.

20. The method of claim 15, wherein based at least in part on receiving the edit, generating an updated training data set based on the edit and the correlated image set for training a machine learning algorithm.
